(19) United States
(12) Patent Application Publication
(10) Pub. No.: US 2008/0317140 A1
(43) Pub. Date: Dec. 25, 2008

(54) Method of Converting a User Bitstream Into Coded Bitstream, Method for Detecting a Synchronization Pattern in a Signal, a Record Carier, a Signal, a Recording Device and a Playback Device

(75) Inventors: Willem Marie Julia Marcel Coene, Eindhoven (NL); Andries Pieter Hekstra, Eindhoven (NL); Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,138

(22) PCT Filed: Sep. 12, 2005
(86) PCT No.: PCT/IB2005/052970

§ 371 Date: Mar. 13, 2007

(30) Foreign Application Priority Data
Sep. 17, 2004 (EP) 04104515.4

(51) Int. Cl. H04B 14/04

(52) U.S. Cl. 375/253

(57) ABSTRACT

This ID proposes synchronization patterns for RLL codes with a (repeated) minimum transition run (RMTR) constraint, where the synchronization pattern comprises a synchronization pattern-body that contains a characteristic bit-pattern that represents a violation of the RMTR constraint. Using a violation of the RMTR constraint allows for short synchronization patterns.

This invention relates to a method of converting a user bitstream into coded bitstream in a signal by means of a channel code, based on a signal format with a number of coded bitstream frames, wherein said channel code has a minimum transition run constraint, denoted r constraint specifying the maximum number of consecutive minimum run lengths, comprising the steps of:
coding the user bitstream into the coded bitstream,
partitioning the coded bit stream into a first section and a second section,
generating the synchronization pattern,
inserting the generated synchronization pattern between the first section and the second section.

Data on an optical disc are organized into ECC-clusters (an ECC-cluster is the collection of all stored symbols that constitute together the structure of the (possibly combined) ECC codes); each cluster is typically organized in a number of recording frames, where each recording frame comprises a limited number of symbols (91 for DVD, 155 for BD). Synchronization patterns are required at the start of each recording frame in order to yield the proper starting point for the sequence of channel bits that has to enter the runlength-limited (RLL) decoder: a shift of a single bit is killing for the output of the RLL-decoder. Therefore, synchronization patterns have to be uniquely identifiable in the main channel bitstream. Commonly, a violation of a k-constraint is used as a typical bit-pattern in the synchronization pattern (as in DVD and BD).

Application to d=1 & r=2 RLL Codes

Recently, a new class of RLL codes with a new code construction method has been designed for the d=1 constraint of BD, with, in addition, a RMTR constraint (repeated minimum transition run) of r=2, which is advantageous for robust bit-detection since it yields an additional 0.9 dB of SNR margin. Prior to this new class of codes, a first code with k=12 has been derived. After that, a number of codes has been derived using the new construction method. All these codes have a k constraint larger than that of BD (k=7 for 17PP). A k constraint of 14 is not uncommon. Consequently, there are two major disadvantages with respect to a synchronization patterns constructed with the state-of-the-art procedure, that is, based on a violation of the k-constraint: (i) such a synchronization pattern requires more overhead, and (ii) with the use of (very) long runlengths in the synchronization pattern (e.g. 2 bits longer than the maximum runlength k+1), the probability of false synchronization pattern detection becomes larger, especially at high capacities (beyond 30 GB for a BD-like readout channel, with λ=405 nm and NA=0.85).

Reason to Use r=2 RLL Codes

At very high densities for a d=1 constrained storage system, consecutive 2T runs are the Achilles' heel for the bit-detection. Such sequences of 2T runs bounded by larger runlengths at both sides, are called 2T-trains. Therefore, it turns out to be advantageous to limit the length of such 2T-trains. This is a general observation, and is not new as such. Currently, the 17PP code of BD as disclosed by T. Narahara, S. Kobayashi, M. Hattori, Y. Shimpuku, G. van den Enden, J. A. H. M. Kahlman, M. van Dijk and R. van Woudenberg, in “Optical Disc System for Digital Video Recording”, Jpn. J. Appl. Phys., Vol. 39 (2000) Part 1, No. 2B, pp. 912-919, has a so-called RMTR constraint (Repeated Minimum Transition Runlength) of r=6, which means that the number of consecutive minimum runlengths is limited to 6 (or, equivalently, the maximum length of the 2T-train is 12 channel bits). In the literature, the RMTR constraint is often referred to as the MTR constraint. Originally, the maximum transition-run (MTR) constraint as introduced by J. Moon and B. Brickner, “Maximum transition run codes for data storage systems”, IEEE Transactions on Magnetics, Vol. 32, No. 5, pp. 3992-3994, 1996, (for a d=0 case) specifies the maximum number of consecutive “1”-bits in the NRZ bitstream (where a “1” indicates a transition in the bi-polar channel bitstream). Equivalently, in the NRZI bitstream, the MTR constraint limits the number of successive 1T runs. As argued above, the MTR constraint can also be combined with a d-constraint, in which case the MTR constraint limits the number of consecutive minimum runlengths (as is the case for the 17PP code). The basic idea behind the use of MTR codes is to eliminate the so-called dominant error patterns, that is, those patterns that would cause most of the errors in the partial response maximum likelihood (PRML) sequence detectors used for high density recording. The ETM-code disclosed by K. Kayanuma, C. Noda and T. Iwanaga, in “Eight to Twelve Modulation Code for High Density Optical Disk”, Technical Digest ISOM-2003, Nov. 3-7, 2003, Nara, Japan, paper We-F-45, pp. 160-161, has d=1, k=10 and r=5 constraints, the latter being just one lower than the RMTR of 17PP.

It is a problem of the above codes that no efficient synchronization patterns are available.

It is therefore the objective of the present invention to provide efficient synchronization patterns.

In order to achieve this objective the synchronization pattern comprises a synchronization pattern body comprising a bit-pattern that represents a violation of said minimum transition run constraint r.

Contrary to the common synchronization patterns not a violation of the k-constraint is used for synchronization patterns, but a violation of the r constraint. For example in a code where, r=n: this means that the maximum succession of minimum run lengths (2T runs) equals n. Employing a synchronization pattern with a number of consecutive minimum runlengths larger than n allows an easy detection of the violation. Furthermore because the r constraint is smaller than the typically used k constraint, the number of bits needed before a violation can be detected is smaller, leading to shorter synchronization patterns because fewer bits are needed by the synchronization pattern to create a violation of the r constraint. Smaller synchronization patterns occupy less channel space and allow more data to be transferred in a given channel capacity. Thus a code employing synchronization patterns according to this invention is more efficient, thus achieving the objective of the invention.

In an embodiment of the method r=2.

For a code with a r constraint equal to 2 a violation by the synchronization patterns of the r constraint can be quickly detected. Because the r constraint is smaller than the typically used k constraint, the number of bits needed before a violation can be detected is smaller, leading to shorter synchronization patterns because fewer bits are needed by the synchronization pattern to create a violation of the r constraint. The resultant smaller synchronization patterns occupy less channel space and allow more data to be transferred in a given channel capacity. Thus a code employing synchronization patterns according to this invention is more efficient, thus achieving the objective of the invention

In a further embodiment of the method the violation of the r=2 constraint comprises a sequence of exactly 4 consecutive minimum run lengths.

For instance for r=2 code a violation can already be reliably detected when 4 consecutive minimum runlength are encountered. For a d=1 code this is equivalent to 8 bits which is a very short synchronization pattern compared with synchronization patterns that rely on a violation of the k constraint. A more efficient use of the channel is thus obtained. Four consecutive minimum runlengths represents an excellent balance between reliability in detection and efficient use of the available channel capacity. Three consecutive minimum run lengths would already constitute a violation of the r=2 constraint, and would thus constitute a valid synchronization pattern as covered by the previous embodiment, the present embodiment enables a more robust detection as is important for synchronization patterns.

In a further embodiment of the method the synchronization pattern comprises p leading bits and q trailing bits such that all channel code constraints are met by a last code word of the first section together with the p leading bits and by a first code word of the second section together with the q trailing bits.

In other words a synchronization pattern is used which can be inserted freely in the header preceding a section of the coding bit stream in a coded bit stream frame that has been encoded with said channel code, such that a runlength violations never occurs at a boundary between the synchronization pattern and the section of the coded bit stream.

By ensuring that the channel constraints are met by a last code word of the first section together with the p leading bits and by a first code word of the second section together with the q trailing bits the synchronization pattern becomes freely insertable, i.e. the synchronization pattern does not require particular states at the end of the first section or the beginning of the second section between which it is inserted, but instead is easily adapted to the states at the end of the first section or the beginning of the second section by adjusting the p leading bits and the q trailing bits of the synchronization pattern. Hence the synchronization pattern no longer requires the second section to start in a particular state, allowing the coding and decoding to ignore the synchronization pattern thus achieving the improved efficiency. This can be achieved at the same time as the violation of the minimum transition run constraint r since the violation of the minimum transition run constraint r can be located between the p leading bits and the q trailing bits of the synchronization pattern

It is advantageous to use a synchronization pattern that is freely insertable into the channel bitstream that is generated by a RLL-encoder based on a finite-state machine.

Finite-state machines often use a large number of coding states. The coding state as defined by the next code word determines what code word the user input words will be coded into. For decoding the next code word is thus needed to determine the coding state which in turn is needed to determine the user input word.

When a synchronization pattern is inserted into the channel bit stream this relationship is interrupted. For DVD the synchronization word resets the coding state to state 1 at the end of the synchronization pattern and thus limits the choice of the first code word after the synchronization pattern. This limitation results in an inefficient coding.

By using a free insertable synchronization pattern where the end of the synchronization pattern represents the same coding state as the code word before the synchronization pattern, all code words that could be used when no synchronization pattern were present can be used after the synchronization pattern. Thus no efficiency is lost by using the free insertable synchronization pattern compared to the situation where no synchronization pattern were present.

As outlined in the BD-standard, it may be advantageous to identify the different recording frames by the frame synchronization pattern of a current recording frame together with the frame synchronization pattern of one of the preceding recording frames. In BD, there are 7 specially designed 6-bit synchronization pattern ID's for this purpose.

A method for detecting a synchronization pattern in a signal comprising a user bitstream coded into a coded bitstream by means of a channel code, based on a signal format with a number of coded bitstream frames, whereby each coded bitstream frame is preceded by a header comprising a synchronization pattern, wherein said channel code has a minimum transition run constraint r, specifying a maximum number of consecutive minimum run lengths, comprising the steps of:
earching the signal for bit pattern that represents a violation of said minimum transition run constraint r.

Detection of the synchronization pattern is easy. Once a bit pattern is found that constitute a violation of the minimum transition run constraint r, the synchronization pattern comprising the bit pattern is found.

A further embodiment of the method for detecting a synchronization pattern includes the step of:
performing a correlation detection with a matched filter based on a characteristic synchronization pattern-body and an expected nominal channel response.

Since a specific bit pattern is to be detected a correlation detection with a matched filter is a suitable method for detection that achieves fast detection.

A further embodiment of the method for detecting a synchronization pattern includes the step of:
performing a correlation detection with a filter-bank of matched filters, each of said filters corresponding with a total synchronization pattern of synchronization pattern-body and a synchronization pattern-ID for one of the possible multitude of synchronization pattern-IDs, and where each of said matched filters is further based on a same expected nominal channel response.

Since specific bit patterns are to be detected a correlation detection with a matched filter is a suitable method for detection that achieves fast detection. To detect multiple bit pattern, a bank of filters, each adjusted to find a particular bit pattern, allows a fast detection of the bit pattern.

According to the invention a record carrier comprises a user bitstream into a coded bitstream in a signal by means of a channel code, based on a signal format with a number of coded bitstream frames, wherein said channel code has a minimum transition run constraint, denoted r constraint specifying the maximum number of consecutive minimum run lengths, where the signal comprises a synchronization pattern inserted between a first section of the coded bit stream and a second section of the bit stream where the synchronization pattern comprises a synchronization pattern body comprising a bit-pattern that represents a violation of said minimum transition run constraint r.

A record carrier according to the invention benefits from the synchronization pattern because the r constraint is smaller than the typically used k constraint. The number of bits needed before a violation can be detected is smaller, leading to shorter synchronization patterns because fewer bits are needed by the synchronization pattern to create a violation of the r constraint. Smaller synchronization patterns occupy less storage space and allow more data to be stored on a record carrier with a given capacity compared to the situation where a violation of the k constraint is used in the synchronization pattern.

According to the invention a signal comprises a user bitstream into a coded bitstream in the signal by means of a channel code, based on a signal format with a number of coded bitstream frames, wherein said channel code has a minimum transition run constraint, denoted r constraint specifying the maximum number of consecutive minimum run lengths, where the signal comprises a synchronization pattern inserted between a first section of the coded bit stream and a second section of the bit stream where the synchronization pattern comprises a synchronization patternbody comprising a bit-pattern that represents a violation of said minimum transition run constraint r.

A signal according to the invention benefits from the synchronization pattern because the r constraint is smaller than the typically used k constraint. The number of bits needed before a violation can be detected is smaller, leading to shorter synchronization patterns because fewer bits are needed by the synchronization pattern to create a violation of the r constraint. Smaller synchronization patterns occupy less channel space in the signal and allow more data to be transferred by the signal given a channel capacity compared to the situation where a violation of the k constraint is used in the synchronization pattern.

According to the invention a recording device for recording a user bit stream on a record carrier comprises an input arranged to receive a user bitstream and to provide the user bitstream to a coder arranged to code a user bitstream into a coded bitstream by means of a channel code with a minimum transition run constraint r specifying a maximum number of consecutive minimum run lengths, and a synchronization pattern insertion device for generating and inserting the synchronization pattern in the signal between a first section of the coded bitstream and a second section of the coded bitstream, and recording means for recording the coded bitstream in a signal on the record carrier where the synchronization pattern, the synchronization pattern comprising a synchronization pattern body comprising a bit-pattern that represents a violation of said minimum transition run constraint r.

A recording device according to the invention benefits from the synchronization pattern because the r constraint is smaller than the typically used k constraint. The number of bits needed before a violation can be detected is smaller, leading to shorter synchronization patterns because fewer bits are needed by the synchronization pattern to create a violation of the r constraint. Smaller synchronization patterns occupy less storage space and allow more data to be stored on a record carrier with a given capacity using the recording device according to the invention, compared to the situation where a violation of the k constraint is used in the synchronization pattern.

According to the invention a playback device for converting a coded bitstream in a signal on a record carrier into a user bit stream using a channel code with a constraint comprises a signal retrieval device arranged for retrieving the signal from the record carrier, the playback device comprising a synchronization pattern detection device arranged for detecting a synchronization pattern retrieved from the signal from the record carrier by synchronization pattern retrieval means, the signal comprising a coded bit stream with a minimum transition run constraint r specifying a maximum number of consecutive minimum run lengths recorded in recording frames, the synchronization pattern comprising a synchronization pattern body comprising a bit-pattern that represents a violation of said minimum transition run constraint r.

A playback device according to the invention benefits from the synchronization pattern because the detection of the synchronization pattern is easy. Once a bit pattern is found that constitute a violation of the minimum transition run constraint r, the synchronization pattern comprising the bit pattern is found. Since the r constraint allows shorter synchronization patterns the playback device can detect the synchronization patterns quicker allowing a shorter access time to the user bit stream.

The invention will now be described based on figures.

### THE INVENTION WILL NOW BE DESCRIBED BASED ON FIGURES

FIG. 1 shows a freely insertable Synchronization pattern, that violates the r constraint, between two successive Code Words of a Sliding-Block RLL Code.

FIG. 2 shows a freely insertable Synchronization pattern that violates the r constraint, between two successive Code Words of a Sliding-Block RLL Code in a frame structure.

FIG. 3 shows a structure of the insertable synchronization pattern with a r=2 violation for a d=1 code

FIG. 4 shows a recording device.

FIG. 5 shows a playback device.

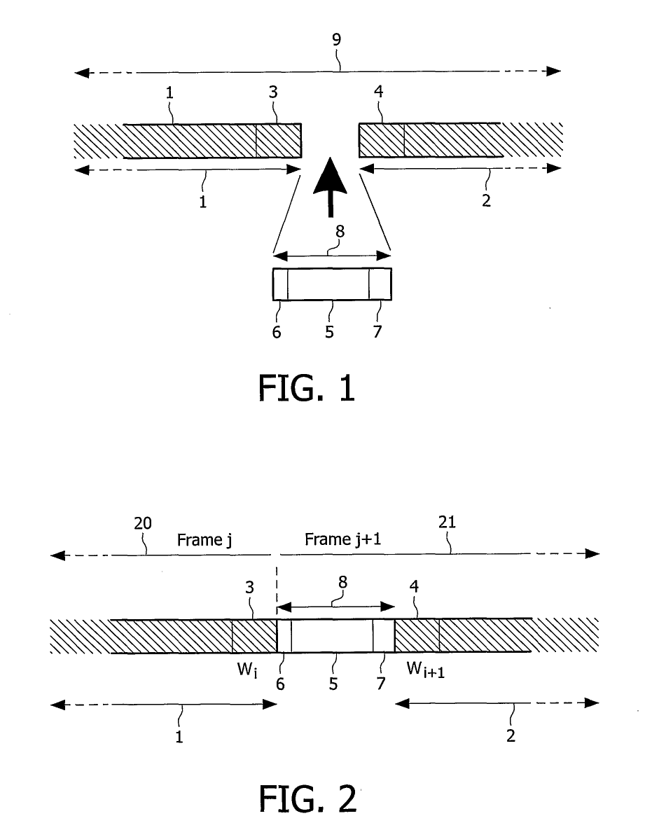

FIG. 1 shows a freely insertable Synchronization pattern, that violates the r constraint, between two successive Code Words of a Sliding-Block RLL Code.

FIG. 1 shows the insertion of a synchronization pattern 8 between a first section 1 of the coded bitstream and a second section 2 of the coded bit stream. A first channel word, i.e. code word 3 is located at the end of the first section 1 and a second channel word, i.e. code word 4, is located at the beginning of the second section 2.

Because the coded bitstream is divided into two sections, each section complies with the constraints as applied by the channel code.

The first code word 3 is further denoted Wᵢ and the second code word 4 is denoted Wᵢ₊₁.

The synchronization pattern 8 comprises a synchronization pattern body 5. Adjacentto the a synchronization pattern body 5 trailing bits 6 and leading bits 7 are shown. These trailing bits 6 and leading bits 7 are optional and can be used to maintain a channel code constraint partly in the synchronization pattern near the boundaries with the preceding code words 3 and following code words 4. For instance when using a block decoder or sliding window decoder, decoding the first code word Wᵢ into the corresponding user symbol or user word requires “look-ahead” into the next, i.e. second, code word Wᵢ₊₁. Because the first code word Wᵢ and the second code word Wᵢ₊₁ were encoded sequentially by the coder using the channel code with the constraint r=2 the combination of the first code word Wᵢ and the second code word Wᵢ₊₁ complies with that constraint.

In view of maintaining the r=2 constraint at the boundary between code words Wᵢ, Wᵢ₊₁ and synchronization pattern 8, the first two bits 6 and the last two bits 7 of the synchronization pattern 8 should be zero for a code with r=2. For instance, a synchronization pattern 8 may not start with |01 . . . , where “|” denotes the start or end of a group of bits such as the synchronization pattern 8, since that would violate the r=2 constraint in case the preceding code word ends with . . . 0010101|. It should be noted however that even though the leading bits 31 and the trailing bits ensure a certain amount of compliance at the boundaries with the r constraint, the synchronization pattern as a whole, and the synchronization pattern body in particular does violate the r constraint.

FIG. 2 shows a freely insertable Synchronization pattern that violates the r constraint, between two successive Code Words of a Sliding-Block RLL Code in a frame structure.

In FIG. 2 the first section 1, second section 2 and synchronization pattern 8 are shown, after insertion of the synchronization pattern, in relation to a frame structure as often used on a record carrier. The start of a next frame 21 is indicated by the dotted line. The next frame is denoted frame j+1. The previous frame 20 preceding the next frame 21 is denoted frame j.

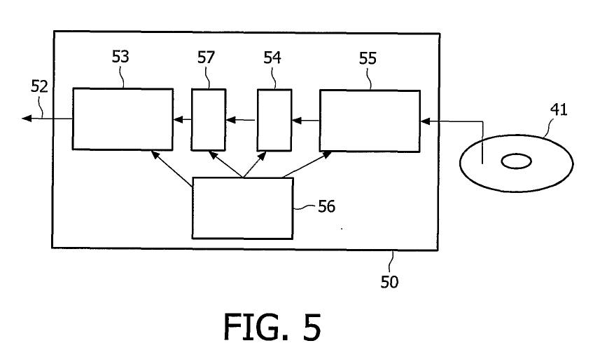

The next-state decoding for first code word W (which is the last code word 3 of frame j) proceeds by just ignoring the synchronization pattern 8 as identified by the synchronization pattern detection device 54 of FIG. 5, before the subsequent second code word 4, which is the first code word of the next frame j+1. Also, the state in which the encoder resides after a synchronization pattern 8, is in this example, not reset to a fixed state as in the state-of-the-art solution, due to the use of the trailing bits 33, but is dictated by the next-state of the last encoded code word, in this example the first code word 3 at the end of previous frame j, as given by the FSM (and thus as is listed the code-tables of the channel code used).

Extremely efficient d=1 and r=2 RLL codes have been recently devised. Those RLL codes are realized as a concatenation of a number of sub-codes, where each sub-code is described in terms of a finite-state machine (FSM) with a large number of states. For instance, in the case of a byte-oriented RLL code with six sub-codes, five out of which have a 8-to-12 mapping (i.e. mapping 8 user bits onto 12 channel bits), and one has a 8-to-11 mapping, the resulting code-rate of the overall code amounts to R=48/71. The latter code has RLL constraints: d=1, r=2 and k=22. The k=22 constraint is realized through the property that each code word has at maximum 11 leading or trailing zeroes (and the all-zero code word is forbidden). The respective number of states of the FSM's of the six sub-codes C₁, C₂, C₃, C₄, C₅ and C₆ are: 28, 26, 24, 22, 20, 19. As an example, take a code word of C₆, where the next symbol is encoded with C₁: for some code words, the one-symbol look-ahead decoder has to differentiate between the maximum of 28 possible next-states. Incorporating this next-state diversity within the synchronization pattern (as is done in the state-of-the-art solution) would lead to a considerable increase of the length of the synchronization pattern, and this might partly prohibit the effectiveness of the gain in coding efficiency of the new RLL codes (the code being very efficient, but requiring too long synchronization patterns).

The solution to the above problem is to devise synchronization patterns that can readily be inserted (or pasted) into an RLL bitstream that has been generated by means of the sliding block encoder and its FSM. Such an “insertable” synchronization pattern is one that does not lead to runlength violations at its two boundaries, one between for instance the preceding code word and the synchronization pattern, the other between the synchronization pattern and for instance the subsequent code word.

FIG. 3 shows a structure of the insertable synchronization pattern with a r=2 violation for a d=1 code.

A synchronization pattern 30 suitable for a d=1 and r=2 code comprises a sequence of 4 2T runs in a synchronization pattern body 34, thus violating the RMTR constraint of r=2. The synchronization pattern comprises a common synchronization pattern-body 34, a separate synchronization pattern-ID 32 (of 6 bits as an example, with bits i₀, i₁, . . . , i₅), leading bits 31 and trailing bits 33.

The example shown includes the leading bits 31 and trailing bits 33 as this provides the additional properties that the synchronization pattern 30 is free-insertable due to the leading bits 31 and trailing bits 33.

The general form of the synchronization pattern 30 is:

|00 1̅0̅″̅10 1̅0̅10 1̅0̅10″ 1̅0̅i₀i₁i₂i₃i₄i₅ 00|. (1)

For one possible choice of the polarity, the consecutive run lengths of opposite polarity are indicated by underlining or overlining the respective run lengths. The 4 consecutive 2T runs are indicated by ‘10101010’. Note that in Eq. (1), the channel bits are presented in (d, k)-notation, implying that a “1” indicates the start of a new run, and that a “0” indicates the continuation of an already started run. The ‘n’ next to the ‘0’ indicates the number of consecutive zeros. The consecutive runs (of the bi-polar channel bits, representing the lengths of the physical marks (or pits) and non-marks on the disc) are indicated by the underlining c.q. overlining.

The length of the complete synchronization pattern amounts to 22+2n bits. As a result, the sync-body contains the sequence of run lengths:

| (̅n̅+̅1̅)̅T̅|2T| 2̅T̅|2T| 2̅T̅|(n+1)T| (2)

so that the 4 consecutive 2T runs have two longer runs consisting of n+1 bits, and of opposite polarity as neighboring runs. When taking for instance n=4, the total synchronization pattern comprises 30 bits (as in the BD standard), and with 5T runs neighboring the 2T-train: this is sufficiently long in order to generate a high enough signal amplitude (or modulation) in the center of the 5T runs.

By ensuring that the channel constraints are met by a last code word of the section preceding the synchronization pattern 30 together with the p leading bits 31 and by a first code word of the section of the coded bitstream following the synchronization pattern 30 together with the q trailing bits 33 the synchronization pattern becomes freely insertable, i.e. the synchronization pattern 30 does not require particular states at the beginning of the section following the synchronization pattern 30, but instead is easily adapted to the states at the end of the first section or the beginning of the section following the synchronization pattern 30 by adjusting the p leading bits 31 and the q trailing bits 33 of the synchronization pattern 30. Hence the synchronization no longer requires the section following the synchronization pattern 30 to start in a state state dictated by the synchronization pattern 30, allowing the coding and decoding to ignore the synchronization pattern 30 thus achieving the improved efficiency.

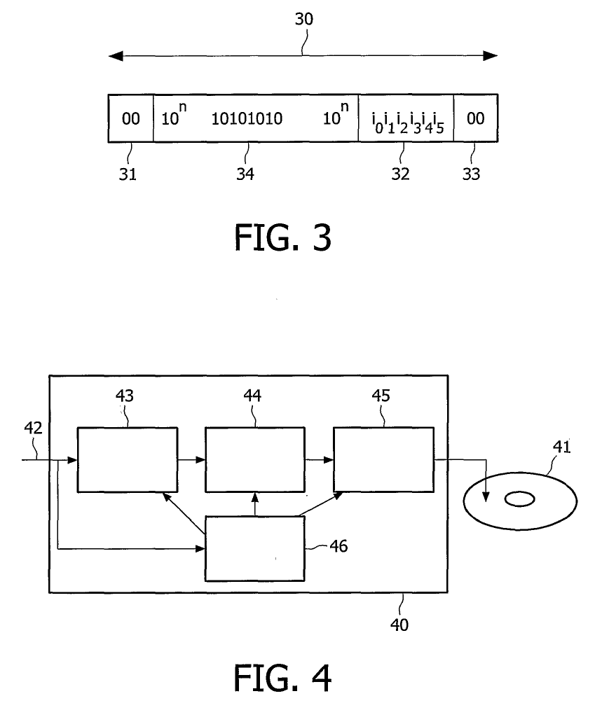

FIG. 4 shows a recording device 40 for recording a user bit stream on a record carrier 41. The input 42 receives a user bit stream that is to be recorded on the record carrier 41 and provides this user bit stream to the coder 43. In addition, the user bit stream or instructions for the recording device 40 can also be provided to a central processing device 46 to allow the appropriate coordination of the recording process under control of this central processing device 46. To achieve this coordination the central processing device 46 is coupled to the various devices 43, 44, 45 comprised in the recording device 40. The coder 43 uses a channel code to code the user bitstream received from the input into a coded bitstream. This channel code has a constraint, for instance a k constraint or an r constraint. The coded bitstream is subsequently provided by the coder 43 to the synchronization pattern insertion device 44. The synchronization pattern insertion device 44 generates, based on the chosen insertion point in the coded bitstream, a synchronization pattern that violates the r constraint, splits the coded bit stream into a first section and a second section and inserts the generated synchronization pattern between the first section and the second section of the coded bit stream. This results in a bit stream that is suitable for recording by the recording means 45 in the form of a signal on the record carrier 41. The synchronization pattern insertion device 44 generates the synchronization pattern such that the synchronization pattern comprises a synchronization pattern body comprising a bit-pattern that represents a violation of said minimum transition run constraint r.

FIG. 5 shows a playback device 50 for converting a coded bitstream in a signal on a record carrier 41 into a user bit stream using a channel code with a constraint. The playback device 50 comprises a signal retrieval device 55 arranged for retrieving the signal from the record carrier 41. The signal retrieval device 55 provides the retrieved signal, comprising the coded bitstream with the inserted synchronization pattern to the synchronization pattern detection device 54 where the synchronization pattern is detected using correlation detection with a matched filter based on a characteristic synchronization pattern-body and an expected nominal channel response. The synchronization pattern detection device 54 removes the synchronization pattern after detection from the signal and provides the first section of the coded bitstream and the second section of the coded bitstream to the appending device 57 where the second section is appended to the first section to recreate a recreated coded bitstream. This recreated coded bitstream is subsequently provided by the appending device 57 to the decoder 53. The decoder 53 decodes the recreated coded bitstream into the user bitstream and provides the user bitstream to the output 52. The playback device also comprises a central processing device 56 that coordinates the various devices 53, 54, 55, 57 in the playback device 50.

Detection of the synchronization pattern by the synchronization pattern detection device 54 is carried out on the HF signal waveform in the bit-synchronous domain. A correlation detection is performed with a matched filter for the sequence of characteristic runlengths as outlined in Eq. (2). This implies that the possibly un-equalized signal waveform is correlated with the expected signal waveform for the considered sequence of bits in the synchronization pattern-body, that applies for the targeted density under non-aberrated nominal read-out conditions.

In the case without pit-land asymmetry, it suffices to correlate with only one expected signal waveform, which will lead to either +1 or −1 as the output of the correlation detection.

In the case with pit-land asymmetry, one can perform the correlation using two expected signal waveforms for the sync-body, one for each of the two polarities of the waveform Note that only one polarity is shown in Eq. (2). In that case, only a positive outcome of the correlation detector is considered.

It should be noted that the synchronization pattern is not detected from the bitstream that results from the (PRML) bit-detector as located in the signal retrieval device 55.

The retrieved signal can however be provided to the synchronization pattern detection device 54 by the signal retrieval device 55 without performing the (PRML) bit detection, i.e. in its raw form. This allows the synchronization pattern detection device 54 to detect the synchronization pattern and use the knowledge of the position of the synchronization pattern to remove the corresponding synchronization pattern at the corresponding position in the bit stream obtained using the (PRML) bit detection. The latter bit-detector cannot cope with the r=2 violations of the sync-pattern. However, the matched filter detector detects the sync-pattern over the complete sequence of bits of the sync-body, and possibly over the complete length of the sync, inclusive of the sync-ID, when matched filters are designed for each of the possible sync-IDs, and is therefore very reliable.

1. A method of converting a user bitstream into coded bitstream in a signal by means of a channel code, based on a signal format with a number of coded bitstream frames, wherein said channel code has a minimum transition run constraint, denoted r constraint specifying the maximum number of consecutive minimum run lengths, comprising the steps of:
coding the user bitstream into the coded bitstream,
partitioning the coded bit stream into a first section and a second section,
generating the synchronization pattern,
inserting the generated synchronization pattern between the first section and the second section,
where the synchronization pattern comprises a synchronization pattern body comprising a bit-pattern that represents a violation of said minimum transition run constraint r.

2. A method as claimed in claim 1, where r=2.

3. A method as claimed in claim 1, where to achieve the violation of the r=2 constraint the synchronization pattern comprises a sequence of exactly 4 consecutive minimum run lengths.

4. A method as claimed in claim 1, where the synchronization pattern comprises p leading bits and q trailing bits such that all channel code constraints are met by a last code word of the first section together with the p leading bits and by a first code word of the second section together with the q trailing bits.

5. Method for detecting a synchronization pattern in a signal comprising a user bitstream coded into a coded bitstream by means of a channel code, based on a signal format with a number of coded bitstream frames, whereby each coded bitstream frame is preceded by a header comprising a synchronization pattern, wherein said channel code has a minimum transition run constraint r, specifying a maximum number of consecutive minimum run lengths, comprising the steps of:
searching the signal for bit pattern that represents a violation of said minimum transition run constraint r.

6. Method for detecting a synchronization pattern in a signal as claimed in claim 5, where r=2.

7. Method for detecting a synchronization pattern in a signal as claimed in claim 5, where the synchronization pattern comprises a sequence of exactly 4 consecutive minimum run lengths

8. A method as claimed in claim 5, where the detecting a synchronization pattern includes the step of:
performing a correlation detection with a matched filter based on a characteristic synchronization pattern-body and an expected nominal channel response.

9. A method as claimed in claim 5, where the detecting a synchronization pattern includes the step of:
performing a correlation detection with a filter-bank of matched filters, each of said filters corresponding with a total synchronization pattern of synchronization pattern-body and a synchronization pattern-ID for one of the possible multitude of synchronization pattern-IDs, and where each of said matched filters is further based on a same expected nominal channel response.

10. A record carrier comprising a user bitstream into a coded bitstream in a signal by means of a channel code, based on a signal format with a number of coded bitstream frames, wherein said channel code has a minimum transition run constraint, denoted r constraint specifying the maximum number of consecutive minimum run lengths, where the signal comprises a synchronization pattern inserted between a first section of the coded bit stream and a second section of the bit stream where the synchronization pattern comprises a synchronization pattern body comprising a bit-pattern that represents a violation of said minimum transition run constraint r.

11. A signal comprising a user bitstream into a coded bitstream in the signal by means of a channel code, based on a signal format with a number of coded bitstream frames, wherein said channel code has a minimum transition run constraint, denoted r constraint specifying the maximum number of consecutive minimum run lengths, where the signal comprises a synchronization pattern inserted between a first section of the coded bit stream and a second section of the bit stream where the synchronization pattern comprises a synchronization pattern body comprising a bit-pattern that represents a violation of said minimum transition run constraint r.

12. Recording device for recording a user bit stream on a record carrier, the recording device comprising an input arranged to receive a user bitstream and to provide the user bitstream to a coder arranged to code a user bitstream into a coded bitstream by means of a channel code with a minimum transition run constraint r specifying a maximum number of consecutive minimum run lengths, and a synchronization pattern insertion device for generating and inserting the synchronization pattern in the signal between a first section of the coded bitstream and a second section of the coded bitstream, and recording means for recording the coded bitstream in a signal on the record carrier where the synchronization pattern, the synchronization pattern comprising a synchronization pattern body comprising a bit-pattern that represents a violation of said minimum transition run constraint r.

13. Playback device for converting a coded bitstream in a signal on a record carrier into a user bit stream using a channel code with a constraint, comprising a signal retrieval device arranged for retrieving the signal from the record carrier, the playback device comprising a synchronization pattern detection device arranged for detecting a synchronization pattern retrieved from the signal from the record carrier by synchronization pattern retrieval means, the signal comprising a coded bit stream with a minimum transition run constraint r specifying a maximum number of consecutive minimum run lengths recorded in recording frames, the synchronization pattern comprising a synchronization pattern body comprising a bit-pattern that represents a violation of said minimum transition run constraint r.
